(19) United States
(12) Patent Application Publication
(10) Pub. No.: US 2005/0120370 A1
(43) Pub. Date: Jun. 2, 2005

(54) Full option scheduling timer related to media database

(76) Inventor: Hassan Behbehani, Kuwait (KW)

Correspondence Address: Hassan Behbehani, 13013 Safat, P.O. Box: 1262 Safat, Kuwait, KW

(21) Appl. No.: 10/939,355

(22) Filed: Sep. 14, 2004

Related U.S. Application Data
(60) Provisional application No. 60/524,864, filed on Nov. 26, 2003.

(51) Int. Cl. H04N 7/173; G06F 13/00; H04N 5/445; G06F 3/00

(52) U.S. Cl. 725/45; 725/109; 725/112; 725/46; 725/113

(57) ABSTRACT

The presented invention relates particularly with getting media channels schedules in form of database. The database is filled initially with entries comprising program schedules from different sources. The database can be fed with values directly from broad casting stations, some web site or through some external source. After filling the scheduling database, this database can be used for multiple purposes. With each entry of database a specific action can be associated. The database is customizable and can be searched from different angles and different views. A fully functional timer is then associated with database in order to invoke certain actions associated with each entry of database.

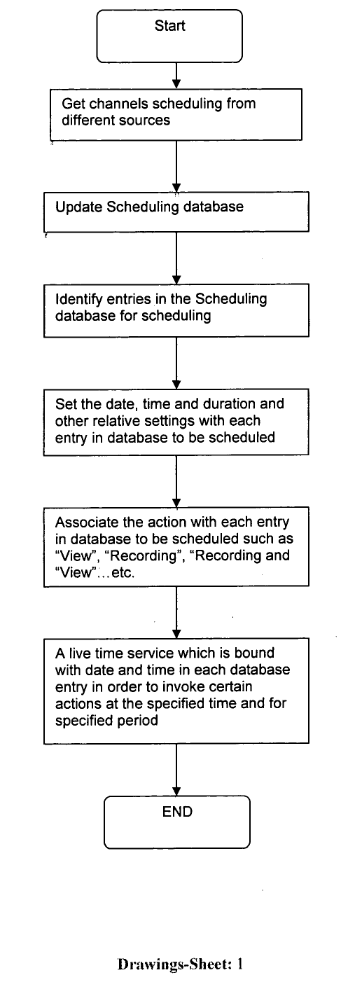

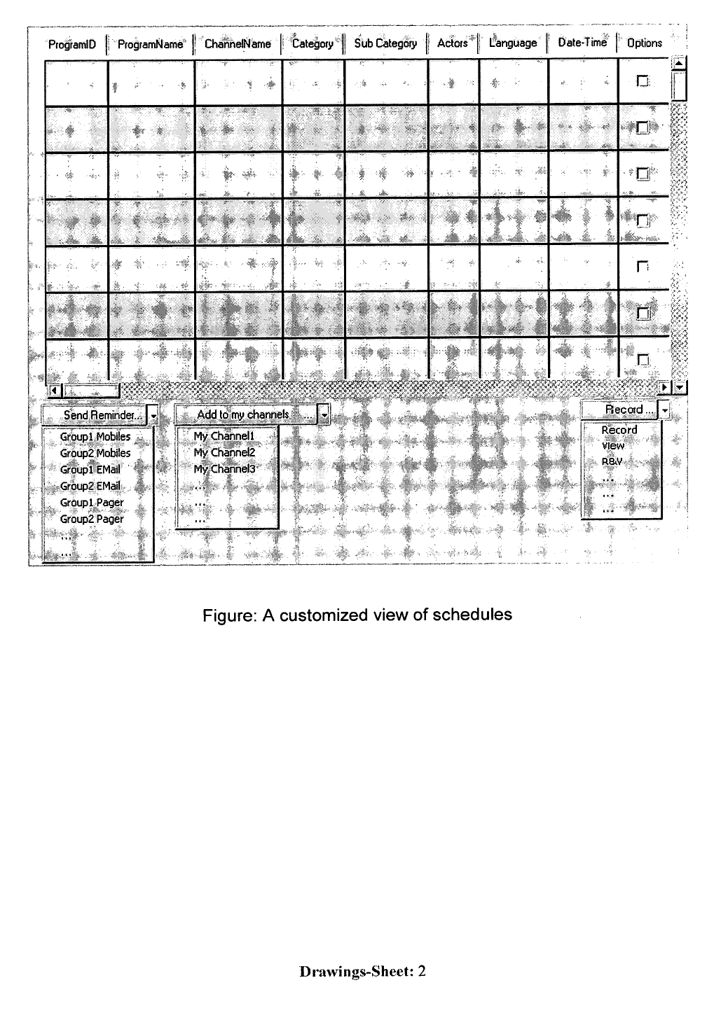

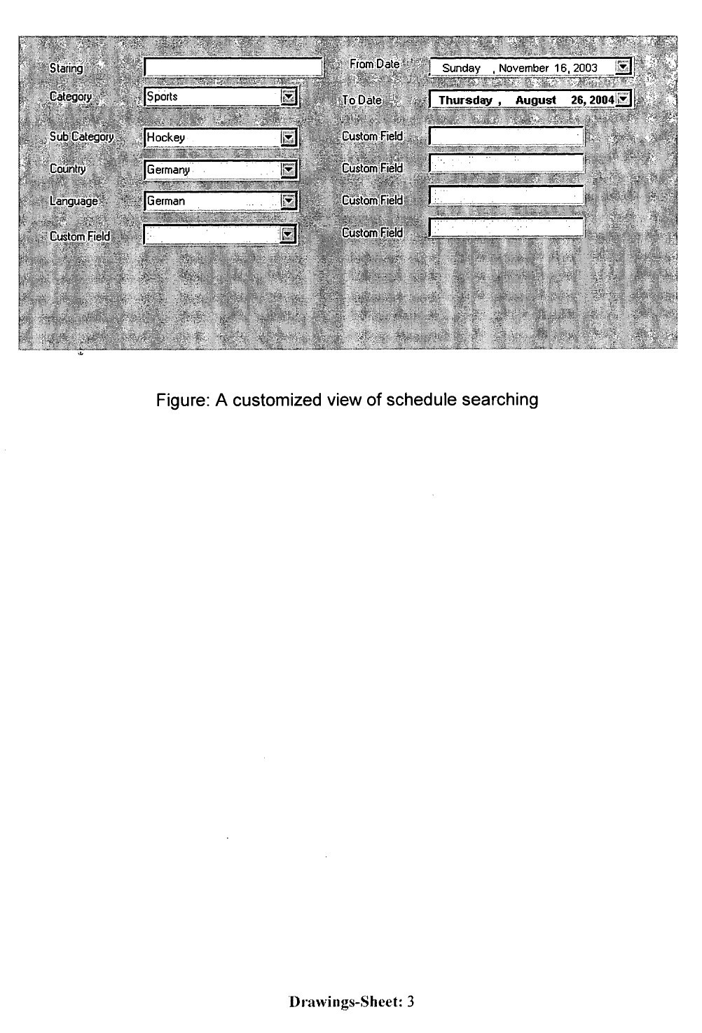

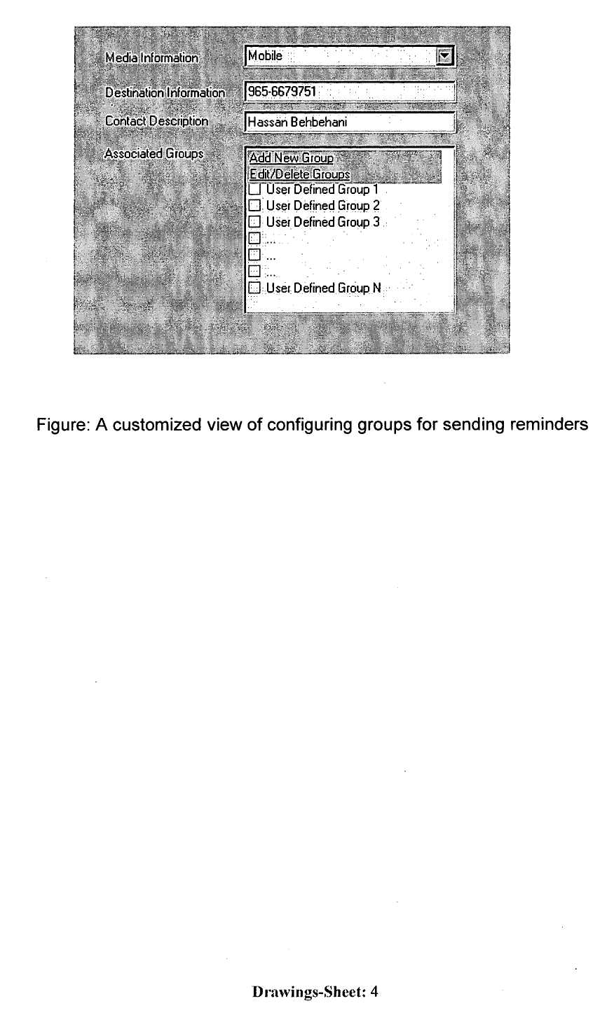

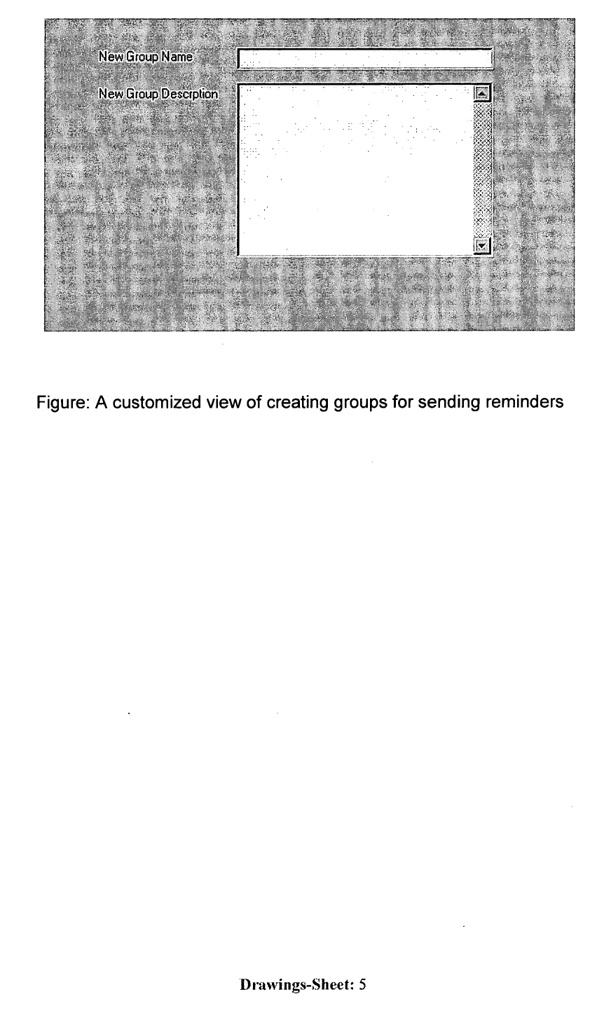

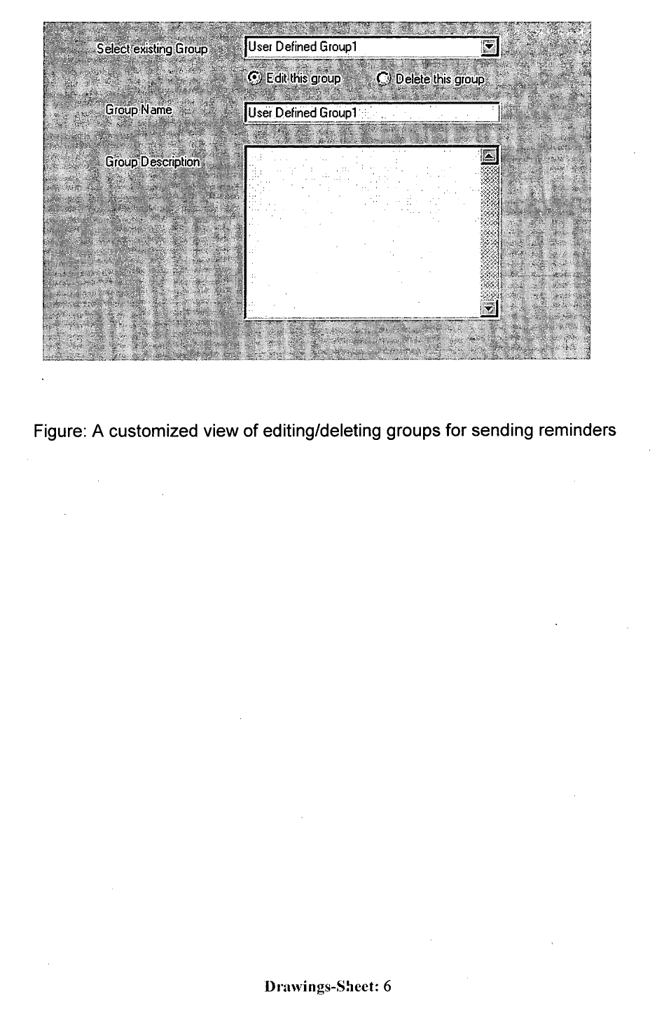

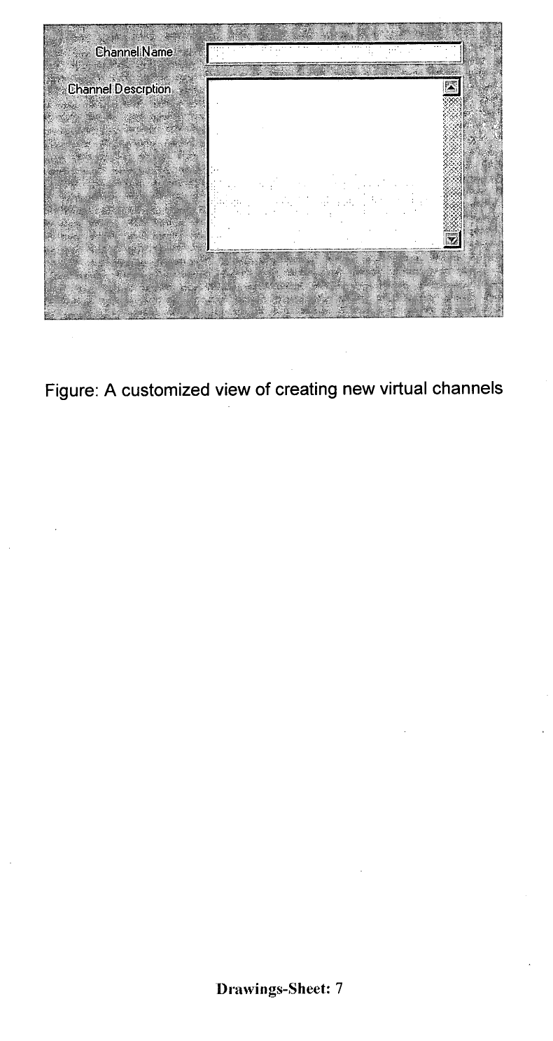

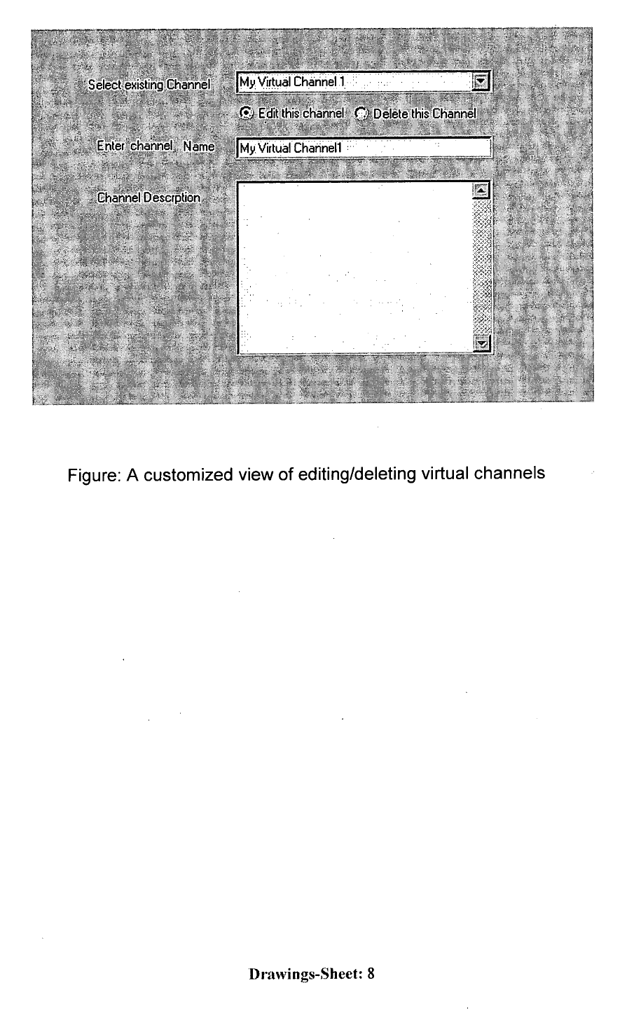

### BACKGROUND OF THE INVENTION

The presented invention relates particularly with getting media channels schedules in form of database. The invention consists of storage media to hold the schedules of different channels. These schedules are stored in database to be resided in the storage media. The database has different kind of fields and can hold entries fed directly by media channel through broadcasting and updating the database. The scheduling database can also be filled by some other technique according to different parameters and factors. The scheduling database is stored in storage media and this scheduling database can be filled through many ways.

Currently different media viewers especially media that works broadcasting like Television have many problems. Broadcasters are used to having it their way. They determine what people watch, when they watch it, the number of commercials they have to endure, and so forth. As in this era, people have become busier and don't have much time. In these tough economic conditions world wide, every one has to do work hard in tough schedules. So as Time is money, every one wants to save this. But still TV viewers want at least some good things like Internet as TV viewers also want to set their own timings and want to watch when they want.

The presented invention helps the viewers and broadcasters as well. With the presented invention, Viewers will not only be able to watch programs of their own interests but also to determine the schedule of their favorite programs. The invention will also help the viewers and other entities involved to record the programs automatically if viewers are not able to watch at some specific time, so they can watch the program later. The viewers will also be able to have schedule of any channel at any time so that chance will be less that viewers will miss the certain programs of their interest. The invention can also be help for different organizations to plan their advertising campaigns effectively.

As the scheduling of the channel is stored in the database, so database is also searchable and customizable. The searching from scheduling database enables the viewers to select variety of programs from many channels according to their interest. They can select the best according to their taste and can watch some currently broadcasting programs immediately and left can be recorded to be viewed later. In database, other program related data is also stored such as Actors, Producer, Program Type . . . etc. This gives the viewer an extra choice to find out the programs on the channels according to their choice and interest. For example, if some viewer wants to watch favorite sport, viewer can search the database for this specific sport for example “Ice Hockey”. This search will bring all the programs from all the channels about “Ice Hockey” so that user can know the schedule. User can also invoke the recording at some specific time and for the specific period so that it can be viewed later. The said invention can also be used in other media such as radio with slight differences.

The invention presented here can also be used for broadcasting companies and TV stations as well. Different TV stations can view the scheduling of other TV Channels in order to make their channel more effective and interesting. In this way, different TV channels can stay ahead for their competitors and quick decisions can be made regarding the broadcasting of different programs. The invention can also be helpful for channels to record different programs from different channels. Mostly channels are used to relay the programs of other channels and also refer to programs from different channels, the said invention can also be helpful in this regards.

The presented new system can also be used by cable operators. Cable operators can use this invention to create virtual TV channels by broadcasting the programs from different channels. Cable operators can schedule recording of programs from different TV channels to broadcast these programs. Cable Operators can fully schedule their daily activities from recording to broadcasting their daily programs.

### BRIEF SUMMARY OF THE INVENTION

The presented invention relates particularly with getting media channels scheduling in form of database. The invention presented here comprises necessarily a storage media to store schedule of different channels. The entries in scheduling database may be entered manually or may be fed directly by TV channel through broadcasting or some web server and updating the database. After filling the scheduling database, certain settings and actions are associated with the desired entries in the database. The entries in the filled scheduled database can be filtered and searched according to provided criteria. This criteria is customizable and depends on the fields that form the scheduling database such as “Channel ID”, “Program Name”, “Program Category”, “Program Sub Category”, “Staring”, Country” and so on. After identifying the desired entries in the scheduling database, the each entry in the scheduling database can be further scheduled according to different parameters at the specified date and time for the specified time.

A fully functional timer that is always active then associated with database in order to invoke certain actions associated with each entry of database. At the specified data and time, the timer invokes the settings associated with different entries in the scheduling database for the specific interval of time if desired.

### BRIEF DESCRIPTION OF THE DRAWINGS

There are eight (8) drawings comprising the working of presented invention. The drawing in sheet 1 is a flowchart of the overall process of the invention. All the symbols used are the standard symbols used in flowcharts otherwise stated. Below here is the description of all the drawings.

Sheet 1:

Technical flow of presented invention.

Sheet 2 (Figure: A customized view of schedules):

The figure shows a customized view of scheduling database. The field shown such as “Program ID”, “Program Name”, Channel ID” . . . etc are for the exemplary purposes. As stated in the description of the said invention, the scheduling database's structure is fully customized. Also the fields' values and structure is also customizable which may have different field names and may have more or less fields.

As stated already the fields values are customizable therefore the values of “Settings” menu are also customizable and may have more or less values with same or different names.

A view similar like this figure is also brought when user searches the scheduling database. Parameters in scheduling database may vary according to different situations but they have the same purpose to facilitate the viewers to identify the schedules of their favorite or wanted programs according to their interest. In the figure above, “Program ID” is identification of each program, “Program Name” is the name or description of program, “Channel Name” is the channel name such as Kuwait TV, BBC, CNN . . . etc.

The “category” and “Sub Category” fields are to categorize the program type such as “News”, “Sports” and “Movie” . . . etc. The sub category field is interlinked with Category field to provide further choices to viewers in broad category. As stated all the fields and their values are customizable, the similar rule is applied here. The program categorization has multiple levels. As category can now have one sub category, similarly each sub category may have further sub categories and so on.

Each row in the table (as presented in figure) can be checked by checking the check box in Options field and then can be scheduled for the value selected in “Settings” drop down box. The “View” setting mean user want to view this channel at the specified time, “Record” means user want to record the specified program automatically at the specified time. The “R&V” (Record and View) combines the both settings. If user chooses “record” setting then recording is done in hidden manner and user is not disturbed and channel is not changed while in “R&V” case channel is also switched to desired program and recording of the program also takes place. As this field is also customizable therefore user may be provided with more or less options as well including or excluding these values fully or partially. Viewer is also able to send each scheduled entry as reminder to mobile phone(s) or email(s) or some other devices. Each entry in scheduling database that has set as reminder is automatically send to specified device as selected in “Send Reminder to.” drop down box before the specified time period such as 2 hours, 15 minutes . . . etc. The reminders can be sent a group of mobile phones or group of emails or some other sort of groups. The invention provides the interface facility to create, edit and delete groups. Each selected entry can also be added to virtual channel created by viewer. The invention also provides the facility to setup viewer's own virtual channels. The viewer is also able to edit and delete a channel which is explained in other figures.

The gird or table in which scheduling database view is displayed provides special features for sorting, filtering and view customization. The column headers or filed names are responsive. For example, if viewer clicks on the column header then the whole view is sorted by according to the values in column whose header is clicked by the viewer. The column headers also provide indicators for sorting orders ascending or descending. Alternate clicks on any column header causes the toggle of sorting order. Relative sorting is also available in the table.

Viewers are also able to customize the layout of the table. Viewer can include or exclude any available field in the view. Viewers are also able to provide the order of fields or column headers. Dragging of any header and dropping it on another header causes the replacement of visual order of the fields or column headers. The correspond columns and values are also moved i.e. only column headers are not moved instead whole columns are moved or interchange their positions.

Sheet 3:

The search enables the viewers to search the schedules of their favorite programs from different channels. The search parameters are highly dependent on the scheduling database fields. Again search parameters are customizable and may contain any field that has been part of the scheduling database itself. The different search parameters may be provided in different situations. The search action displays the all the entries in the scheduling database that falls within the search criteria provided by the viewer.

Search facility is actually the identification of schedules of programs of their interest. Viewer selects different parameters showing his interest and searches. Search results are displayed according to viewer's provided search criteria. Any sort of parameters can be provided in search criteria regardless of their kind and values. The parameters may also be more or less as shown in the fig. The purpose of the figure is just to provide an example; it does not cover the whole scope of parameters that can be used in the search criteria regarding the said invention.

Through the search facility, viewer is able to quickly identify schedules of programs. Viewer can search according to different parameters such as “Staring” field helps the viewer to identify certain programs in which his/her specified actors are working, “Category”, Sub Category”. As described already sub category is interlinked with “Category” and each “Sub Category” can have further sub categories and so on. The parameters “From Date” and “To Date” helps the viewer to identify the schedules within a specified period. No result will be displayed if no program is scheduled is the specified period according to the selected criteria. As described, Search parameters can be customized so other custom fields can also be provided for viewers in order to provide the viewer a comprehensive search facility.

Sheet 4:

The sheet 4 is figure for configuration of different groups to be used for reminders sending. The reminders can be sent to individual as well as to group comprising peers having different devices such as mobiles, email addresses or pagers.

“Media Information” in figure (Sheet 4) is drop down list of all the devices on which the said invention can send the reminders. This field consists of values such as “mobile”, “Email” and “Pager” . . . etc. The value selected by viewer in this field affects the next field named as “Destination Information”. The field “Destination Information” accepts that kind of value that is compatible with the device selected in “Media Information” field. For example, If viewer has selected value “mobile” in “Media Information” field then “Destination Information” accepts phone numbers only and if “Email” is selected then email address needs to be entered in field “Destination Information”. The field “Destination Information” is actually the destination address that may be a phone number and email address . . . etc. At the address specified the reminders are delivered.

“Contact Description” field is used to have a short description of contact as mentioned. “Associated Groups” are the groups of which the mentioned contact has become part of. For example, If a contact is associated with groups a “b” and “c” then when ever the reminder is set to be sent to any of the groups “a”, “b” and “c”, the reminder will also be sent to this contact as well.

The purpose of this interface is to fill the groups with contacts. These filled groups are populated on the main screen as on Sheet 1 when “Send Reminder” field is accessed.

Sheet 5:

The figure shows how to create the groups which are populated on “sheet 1” figure when “Send Reminder” menu is accessed.

“Group Name” field is used to enter the new group name while “Group Description” captures the viewer's description for the defined group.

Sheet 6:

The figure shows the interface to edit/delete the existing groups. Only viewer groups can be deleted. The default groups created by system are not allowed to delete.

“Select existing Group” field is drop down that enlists all the existing groups. Viewer selects the group and then selects the field “Edit this group” or “delete this group.” as required by the viewer. The other two fields are populated from previously stored entries.

Sheet 7:

The figure shows how to create virtual channels which are populated on “sheet 1” figure when “Add to my channels” menu is accessed.

“Channel Name” field is used to enter the new channel name while “Channel Description” captures the viewer's description for the defined channel.

Sheet 8:

The figure shows the interface to edit/delete the existing channels. Only viewer's defined channels can be deleted. The default channels created by system are not allowed to delete.

“Select existing Channel” field is drop down that enlists all the existing channels. Viewer selects the channel and then selects the field “Edit this Channel” or “Delete this Channel” as required by the viewer. The other two fields are populated from previously stored entries.

### DETAILED DESCRIPTION OF THE INVENTION

The presented invention reveals a way to make database comprising schedule of different channels, viewing and searching this database from different angles and parameters and automatically performing different functions according to settings associated with entries in the scheduling database.

The invention presented here comprises necessarily a storage media to store schedule of different channels. The entries in scheduling database may be entered manually or may be fed directly by TV channel through broadcasting and updating the database. The scheduling database can also be filled by some other technique according to different parameters and factors, the main thing is that there is scheduling database that is stored in storage media and this scheduling database can be filled through many ways.

Storage media can be of any kind independent of its locality. The storage media can be located remotely or locally inside the media set such as TV set. The storage media may be any sort of temporary storage, RAM, ROM, Smart card, Chip, Tape, CD, DVD, Computer Floppy Diskette, Computer Hard Diskette... etc. The invention can be used as full fledge software or may be used as firmware. The process of generation and transformation of scheduling database can be in form of software or firmware. For example, There is some special software that can save and retrieve schedules in special format on any storage media (like RAM, ROM, Smart card, Chip, Tape, CD, DVD, Computer Floppy Diskette, Computer Hard Diskette... etc.) The schedules can also be transferred to other destinations through WEB or WAP technology. The presented invention can be installed/setup into TV, Satellite Receiver, Computer or any other devices independent of kind and nature.

The filling up scheduling database actually comprises two main things. First is to retrieve schedule of a certain channel for a specific day from some source.

Secondly bringing the information into scheduling database and updating the database. One way to accomplish this task is to manually entering the schedule of a specific channel for the specific date. This way is much straightforward and simple. Another way is automatically getting the schedule for the certain channels and updating the database. For example, automatically filling the scheduling database directly from corresponding TV Channel's web site or through broadcasting. Another way to retrieve the full channel schedule is to fill the scheduling database as when demanded.

Scheduling database has many fields such as Channel Number, Program Name, Program Language, Country, Translation Language, Program Category, Sub Category, Staring, Date and Time and so on. The database structure is fully customizable and can have more or less fields and may also have different names rather than mentioned as above. Furthermore each field can have different sort of values from constants to different type of variables. For example, some columns may have simple text values; some may have simple set of values such as parameter “Program Category” may have simple values such as Interview, Documentary, Conference, Drama, Sports and Movie . . . etc. Similarly “Sub Category” may have values depending upon the “Program Type” values. For example if “Program Category” is Sports then “Sub Category” may have values like Cricket, Hockey, Tennis and Soccer . . . etc. The fields and values of each field are mapped to some key codes as well. For example, in the above example, Interview may have code 1 and similarly Type field may have code 10. The whole database is editable and customizable and can be formed by the viewer on the basis of different cultures and languages. The database may be filled in any language and can be retrieved in the corresponding language.

Filled scheduling database can be shown to viewers and users. The scheduling entries in the database can be navigated by the viewers and can also update entries in the database. The viewer can also search scheduling database according to different parameters and criteria. For example, user can search all scheduled movies which include his/her favorite actor/actress or viewer can watch the schedule of his favorite sports on different channels.

Once the scheduling database is filled, it is available for viewers to attach certain settings with each entry of their interest in the database. The viewers can attach the settings with each individual entry in database. Now it is the step to schedule the different channels for viewing or recording. User can schedule the specific programs on specific channels on specific date and time. It works similarly like normal scheduling of tasks but here the channels are scheduled. When user schedule a certain channel for specific date and time, user can also associate action to be taken on the specific date and time. For example, Normal Scheduling just will automatically invoke the schedule channel on the specified date and time. At the specified date and time, the user TV set will automatically switch to the channel against which settings have been applied. There are other actions as well that can be associated with each entry in the scheduling database such as Recording and Recording and Viewing. In case of Recording action, user will be switched automatically to the scheduled channel in hidden way and all the broadcastings will be recorded there. The viewer will not be disturbed, and current channel will be continuously visible to the user, the whole recording will be done in the hidden manner. Recording and Viewing setting will cause the current channel to be switched automatically to the new channel. Along with view automatically changed to the scheduled channel, the recording of channel is also invoked. Again Viewer scheduling and settings with the entries in database can be stored in any sort of media independent of its locality. The settings can be retrieved when required or by the time service which is in place to invoke the specified settings for the specified time at the specified date and time.

Another optional setting that can be used with each setting is time duration. Setting the time duration for any option causes the setting to execute and finish again after the set time. When specified time with each setting has been passed then previous status of Channel is backed. Again setting the time duration with any setting is optional and depends on the viewer's choice or manufacturer's choice if scheduling database is already embedded in some smart card or chip and is not updateable later. If storage media hosting the scheduling database is not updateable then another storage media is used to hold only the scheduled entries by the viewer. There are consistency checks and conditions on attaching settings with the entries in the database.

However this timely scheduling is customizable and user can choose different types of scheduling. For example, viewer can select scheduling in which timely conditions are ignored or timely conditions are strictly applied or mix mode of scheduling in which conditions are applied according to some other settings and conditions. There is live service monitoring the time and always connected to database to invoke scheduled channels.

1. A fully customizable media scheduling database's residing on web server and accessible through different protocols and devices via internet, the said system comprising:
One or multiple servers storing the scheduling database having a plurality of television channels and programs which are categorized into a plurality of program genres; and according to other customizable parameters:
a Web page stored on said one or more servers for being accessible to a user with a client computer through the Internet, wherein said Web page includes a scheduler for enabling said user to arrange delivery of said programs to said client device according to a personalized schedule, wherein said scheduler is comprised of:
a plurality of columns of database showing program characteristics such as Program Name, Actors, Category, Sub Category and genre . . . etc along with data-time when this program will be scheduled arranged in form of grid having plurality of rows where in each row having an indicator for selection
Different Action buttons and menus to perform certain actions on the selected row i.e. on the selected program, such as to record a program, to put selected programs into a virtual channel to schedule the program for recording or watching

2. The system of claim 1, wherein said grid is arranged with columns representing the different characteristics of the program.

3. The Internet television system of claim 1, further including a record action button for scheduling the selected program(s) for recording, view or both actions can also be recorded.

4. The Internet television system of claim 1, further including a Send Reminder action button for sending reminders to requested device such as email, mobile . . . etc at the program scheduled time.

5. The system of claim 1, further including a Add to channel button having a menu further to display all the defined channels. By using this button selected channels can be added to already defined channels.

6. The system of claim 1, further including a database stored in said one or more servers with information on said television programs, said program genres, and a program schedule defined on said grid by said user.

7. The system of claim 1, further including means for automatically filling in program schedules along with date and time.

8. The system of claim 1, further including means for updating a database stored in said one or more servers with latest information and other related information such as watched programs.

9. A method for delivering television programs through the Internet to a client computer thereby to devices such as television, comprising:
categorizing said programs into a plurality of program genres;
a Web page stored on said one or more servers for being accessible to a user with a client computer through the Internet, wherein said Web page includes a scheduler for enabling said user to arrange delivery of said programs to said client device according to a personalized schedule, wherein said scheduler is comprised of:
a plurality of columns of database showing program characteristics such as Program Name, Actors, Category, Sub Category and genre . . . etc along with data-time when this program will be scheduled arranged in form of grid having plurality of rows where in each row having an indicator for selection
Different Action buttons and menus to perform certain actions on the selected row i.e. on the selected program, such as to record a program, to put selected programs into a virtual channel to schedule the program for recording or watching

10. The method of claim 9, further including encoding said programs for streaming over the Internet, and storing encoded programs on a server.

11. The method of claim 9, further including providing a description of each program when said programs are categorized into said genres, said description including a genre description, actors and other program information such as language storing said description in a database, and selecting said one of said programs based on said description.

12. The Internet television system of claim 9, further including a record action button for scheduling the selected program(s) for recording, view or both actions can also be recorded.

13. The Internet television system of claim 9, further including a Send Reminder action button for sending reminders to requested device such as email, mobile . . . etc at the program scheduled time.

14. The system of claim 9, further including a Add to channel button having a menu further to display all the defined channels. By using this button selected channels can be added to already defined channels.

15. The system of claim 9, further including a database stored in said one or more servers with information on said television programs, said program genres, and a program schedule defined on said grid by said user.

16. The system of claim 9, further including means for automatically filling in program schedules along with date and time.

17. The system of claim 9, further including means for updating a database stored in said one or more servers with latest information and other related information such as watched programs.

18. The method of claim 9, further including providing a wastebasket icon in said scheduler for removing said selected genre's row.

19. The method of claim 9, further including storing in a database descriptions of said television programs including titles and actors, program category and sub category, said program genres, and a program schedule defined on said grid by said user.

20. A method for a user to schedule television programs for delivery to a client computer through the Internet, comprising:
one or multiple servers storing the scheduling database having a plurality of television channels and programs which are categorized into a plurality of program genres; and according to other customizable parameters.
a Web page stored on said one or more servers for being accessible to a user with a client computer through the Internet, wherein said Web page includes a scheduler for enabling said user to arrange delivery of said programs to said client device according to a personalized schedule, wherein said scheduler is comprised of:
a plurality of columns of database showing program characteristics such as Program Name, Actors, Category, Sub Category and genre . . . etc along with data-time when this program will be scheduled arranged in form of grid having plurality of rows where in each row having an indicator for selection Different Action buttons and menus to perform certain actions on the selected row i.e. on the selected program, such as to record a program, to put selected programs into a virtual channel to schedule the program for recording or watching

21. A system as claimed in claim 20 wherein the said system allows to record the required programs on a variety of devices.
